(19) United States
(12) Patent Application Publication
(10) Pub. No.: US 2013/0260359 A1
(43) Pub. Date: Oct. 3, 2013

(54) APPARATUS AND METHOD FOR DIAGNOSING LEARNING ABILITY

(71) Applicants: Keun Tae Park, Seongnam Si (KR); Nam Sook Wee, Seoul (KR); Doo Seok Lee, Seoul (KR); Jung Kyo Sohn, Seoul (KR); Haeng Moon Kim, Gwacheon (KR); Yong Gil Park, Seongnam Si (KR); Seung Lock Choe, Seoul (KR); Dong Hahk Lee, Seoul (KR); Jong Heon Lee, Seongnam Si (KR); Myung Sung Lee, Seoul (KR)

(72) Inventors: Keun Tae Park, Seongnam Si (KR); Nam Sook Wee, Seoul (KR); Doo Seok Lee, Seoul (KR); Jung Kyo Sohn, Seoul (KR); Haeng Moon Kim, Gwacheon (KR); Yong Gil Park, Seongnam Si (KR); Seung Lock Choe, Seoul (KR); Dong Hahk Lee, Seoul (KR); Jong Heon Lee, Seongnam Si (KR); Myung Sung Lee, Seoul (KR)

(73) Assignee: SK Telecom Co., Ltd., Seoul (KR)

(21) Appl. No.: 13/882,489

(22) PCT Filed: Oct. 31, 2011
(86) PCT No.: PCT/KR2011/008212

§ 371 Date: Jun. 21, 2013

(30) Foreign Application Priority Data
Oct. 29, 2010 (KR) 10-2010-0106481
Nov. 16, 2010 (KR) 10-2010-0114064

(51) Int. Cl. G09B 7/00

(52) U.S. Cl. CPC G09B 7/00
USPC 434/362

(57) ABSTRACT

The present disclosure relates to an apparatus and method for diagnosing a learning ability. The apparatus for diagnosing learning ability includes a receiving unit configured to receive from a terminal chapter-related information or problem-related information which is desirably diagnosed by a learner, and a semantic information generator configured to generate, responsive to each piece of problem information included in the chapter-related information or problem-related information, semantic information with structural information of the problem information, the problem information having subject-specific problem information distinguished from the semantic information.

### CROSS-REFERENCE TO RELATED APPLICATION

The present application is a national phase of International Patent Application No. PCT/KR2011/008212, filed Oct. 31, 2011, which is based on and claims priorities to Korean Patent Application No. 10-2010-0106481, filed on Oct. 29, 2010 and Korean Patent Application No. 10-2011-0114064, filed on Nov. 16, 2010. The disclosures of the above-listed applications are hereby incorporated by reference herein in their entirety.

### FIELD

The present disclosure relates to an apparatus and method for diagnosing learning ability, which is based on a semantic model generated with semantic information.

### BACKGROUND

The statements in this section merely provide background information related to the present disclosure and may not constitute prior art.

Changing surrounding environment with the use of Internet and computers accelerates the educational reformation. In particular, learners can select and use learning methods in a wider range with development of various educational media, and the method of educational service using the internet has been settled as one of popular teaching-learning methods because of the advantage that education is possible at a low cost overcoming time and space barriers.

The technology related to e-learning has been rapidly developed corresponding with such a trend to the point of providing customizable educational services which were impossible in the off-line education with limited human and material resources. For example, the inventors have experienced that the learning services in fine segmentations to fit the learners' personalities and capabilities are available to provide each learner with customized educational contents by considering different capacities of each learner.

However, the inventors have noted than most educational contents provided even by such customized educational services still remain to indoctrinate the learner with knowledge in the one-sided cramming education. That is, once a teacher provided first an online lecture fit to the learner's level, the learner who has taken the lecture could carry out a specific off-line learning process and then check the learning outcome through an evaluation process. The educational services provided through the Internet up to now were little different from the off-line teaching methods in the related art, in that the learning outcomes depend on the offline efforts of the learners who have taken lectures, as described above. Therefore, the inventors have noted that the Internet environment of education capable of deploying bi-directional education fails to utilize its full functionality, for actual improvement of the learners' capabilities.

Accordingly, the inventors have noted self-directed learning as a form of active learning to value the individuality of learners and to maximize the potential of the individuals. The inventors have also noted the self-directed learning is carried out by an exploratory process where the individuals taking initiatives in specific learning courses to explore human and material resources in order to satisfy the inspired learning desire and a process of evaluating the results of the learning by using strategic approaches appropriate to the exploratory process.

However, the inventors have noted such self-directed learning initiative has a degree of limitation in the case of mathematics. In other words, the inventors have also noted the self-directed learning in mathematics with a limited practice to the multiple choice and/or objective forms of question/answer rather demotivates an individual who voluntarily learns.

### SUMMARY

In accordance with some embodiments, an apparatus for diagnosing a learning ability comprises a receiving unit and a semantic information generator. The receiving unit is configured to receive from a terminal chapter-related information or problem-related information subject to diagnose for a learning ability of a learner. And the semantic information generator is configured to generate, responsive to each piece of problem information included in the chapter-related information or problem-related information, semantic information with structural information of problem information, the problem information having subject-specific problem information distinguished from the semantic information.

In accordance with some embodiments, an apparatus for diagnosing a learning ability comprises an information receiving unit, a review operation unit, a learning contents registration unit, a contents providing unit, and a contents selling unit. The information receiving unit is configured to receive a production of learning contents from a supply terminal. The review operation unit is configured to carry out a review to register the learning contents on a learning market. The learning contents registration unit is configured to give the learning contents semantic information based on basic information received from the supply terminal and register the learning contents on the learning market. The contents providing unit configured to transmit purchase information on the learning contents to a consumer terminal accessing the learning market. And the contents selling unit configured to sell the learning contents for sale or learning, when there is a purchase request in response to the purchase information.

In accordance with some embodiments, an apparatus is configured to perform diagnosing the learning ability. The apparatus is configured to receive from a terminal chapter-related information or problem-related information subject to diagnose for learning ability of a learner, to generate, responsive to each piece of problem information included in the chapter-related information or problem-related information, semantic information with structural information of the problem information, the problem information having subject-specific problem information distinguished from the semantic information, by using each piece of problem information included in the chapter-related information or problem-related information, to receive answer data to said each piece of the problem information from the terminal, to generate wrong answer data obtained by performing marking on the answer data, to calculate a weak field on the basis of the semantic information corresponding to the wrong answer data, to generate a logic equation for solving the weak field, and to transmit a solution to the logic equation to the terminal.

### BRIEF DESCRIPTION OF THE DRAWINGS

FIG. 1 is a schematic diagram of a configuration of a learning ability diagnostic system according to at least one embodiment of the present disclosure;

FIG. 2 is a view of a semantic structure of problems stored in a database according to at least one embodiment of the present disclosure;

FIG. 3 is a schematic block diagram of an apparatus for diagnosing learning ability according to at least one embodiment of the present disclosure;

FIGS. 4A to 4C are diagrams of logic models generated by a problem pattern relational structure extractor of FIG. 3 ability according to at least one embodiment of the present disclosure;

FIG. 5A is a diagram of a tree structure of learning subjects according to at least one embodiment of the present disclosure;

FIG. 5B is a diagram of a preceding process of the learning subjects according to at least one embodiment of the present disclosure;

FIG. 5C is a diagram of a relevance between a problem and topic according to at least one embodiment of the present disclosure;

FIG. 6 is a flowchart of a learning diagnostic process of a learning ability diagnostic apparatus according to at least one embodiment of the present disclosure;

FIG. 7 is a detailed flowchart of an equation solving process of FIG. 6 according to at least one embodiment of the present disclosure;

FIG. 8 is a schematic block diagram of a learning ability diagnostic apparatus according to at least one embodiment which provides a learning market; and

FIG. 9 is a schematic block diagram of internal modules of a learning ability diagnostic apparatus according to at least one embodiment which provides a learning market.

### DETAILED DESCRIPTION

The present disclosure provides an learning ability diagnosing apparatus and method for diagnosing an understanding of required concepts for learning and a problem-solving ability by type in accordance with the learning target and the learning history of the learners through a semantic model such as a mathematic problem and for allowing all of users having learning contents to make free commercial transactions of the learning contents on a learning market.

Hereinafter, embodiments of the present disclosure will be described in detail with reference to the accompanying drawings.

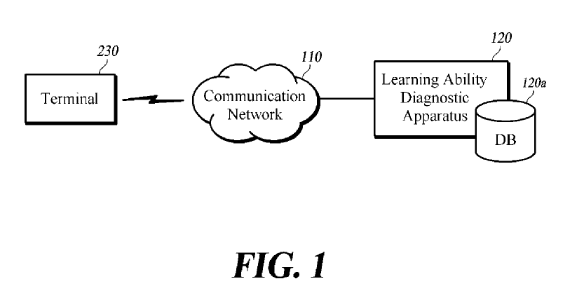

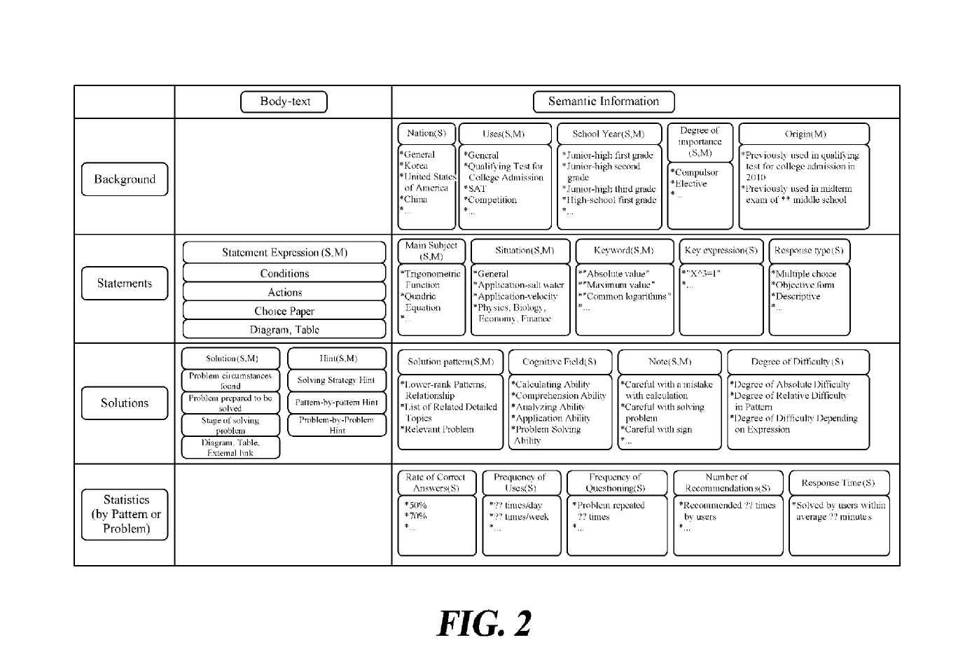

FIG. 1 is a schematic diagram of a configuration of a learning ability diagnostic system and FIG. 2 is a view of a semantic structure of problems stored in a database of FIG. 1, according to at least one embodiment of the present disclosure.

As illustrated in FIGS. 1 and 2, a learning ability diagnosing system includes a learning ability diagnostic apparatus 120 and further includes at least one of a communication network 110 and a terminal 100.

Here, terminal 100 is applicable to diverse wired/wireless environments, and include a web application software for the purpose of, for example, mathematic problem solving. Terminal 100 encompass personal digital assistants or PDAs, cellular phones, smartphones as classified by different form factors, and personal communication service (PCS) phone, global system for mobile (GSM) phones, wideband CDMA (W-CDMA) phones, CDMA-2000 phones, mobile broadband system (MBS) phones as classified by communication methods. Herein, the MBS phone is the terminal for use in the next generation system under current discussion. In addition, terminal 100 may include desktop computers and laptop computers.

Terminal 100 accesses the Internet through communication network 110, using WAP (wireless application protocol) that is an internet access protocol, MIE (Microsoft Internet Explorer) based on HTML using an HTTP (Hyper Text Transfer Protocol) protocol, HDPT (handheld device transport protocol), the i-Mode by NTT DoKomo, or a wireless internet access browser by a specific telecom company. Of the internet access protocols used by terminal 100, MIE uses m-HTML implemented by a little changing and abbreviating HTML, and uses a language called c-HTML, which is a subset of HTML, for i-Mode. Terminal 100, such as the recent smartphone, uses a wireless internet access browser by a specific telecom company such as Opera Mini for i-phone. Or WiFi and WiBro (also called WiMax), which are local communication networks, are used for terminal 100 together with the browser in order to provide faster wireless internet, thereby providing wireless high-speed internet.

Terminal 100 means a device responsive to a learner's key operations or commands for transmitting/receiving various data via communication network 110, and is one of a tablet PC, laptop computer, personal computer or PC, smartphone, PDA and mobile communication terminal. In other words, terminal 100 means a memory for storing programs or protocols for communicating with learning ability diagnostic apparatus 120 via communication network 110, and a microprocessor for executing the relevant programs to effect operations and controls. To be more specific, terminal 100 is any facilitators for server-client communications between learning ability diagnostic apparatus 120 and broadly encompasses any communicating computing devices including the notebook computer, mobile communication terminal, PDA, etc. Hereinafter, terminal 100 is conceptualized to be used by the learner to communicate with learning ability diagnostic apparatus 120 for the purpose of describing the present disclosure.

Communication network 110 implies all of wire/wireless communication networks, and for example, as a wireless communication network, includes at least one of a base station controller, a base station transmitter, and/or a repeater. The base station controller serves to relay signals between the base station transmitter and a switching center. Communication network 110 supports both of the synchronous and non-synchronous types. Therefore, as for a synchronous type, the transmitters of the reception and transmission base stations would be BTSs (base station transmission system), the controllers of the reception and transmission base stations would be BSCs (base station controllers), and as for a non-synchronous type, the transmitters of the reception and transmission base stations would be RTSs (radio transceiver subsystem), and the controllers of the reception and transmission base stations would be RNCs (radio network controller). Communication network 110 according to the present embodiment is not necessarily limited thereto and implies all of those that can be used for the GSM network beyond the CDMA network, and the access networks for the next generation mobile communication systems.

Learning ability diagnostic apparatus 120 according to the present embodiment receives from terminal 100 chapter-related information or problem-related information which is to be desirably diagnosed by a learner. For each piece of problem information included in the chapter-related information or the problem-related information, learning ability diagnostic apparatus 120 further generates semantic information with the structural information of the problem information, having subject-specific problem information from the semantic information. That is, learning ability diagnostic apparatus 120 is implemented as a semantic information generating apparatus that generates only semantic information.

Further, learning ability diagnostic apparatus 120 according to the present embodiment receives from terminal 100 chapter-related information or problem-related information that a learner wants to diagnose. For each piece of problem information included in the chapter-related information or the problem-related information, learning ability diagnostic apparatus 120 generates semantic information with structural information of the problem information, having subject-specific problem information distinguished from the semantic information. Then, learning ability diagnostic apparatus 120 receives answer data for the problem information from terminal 100, generates wrong answer data obtained by grading the answer data, calculates weak fields on the basis of the semantic information corresponding to the wrong answer data, generates a certain logic equation for solving the weak fields, and transmits the solution of the logic equation to terminal 100.

Further, in order to generate the logic equation, learning ability diagnostic apparatus 120, extracts problem pattern information corresponding to the problem information on the basis of the semantic information from the wrong answer data, extracts skill information or conceptual information for the solution of the problem information, extracts the relationship among the problem patterns, the skill information and the conceptual information, and then generates logic equation on the basis of the extracted problem patterns, skill information and conceptual information. Learning ability diagnostic apparatus 120 shows the relational structure of the problem pattern information, the skill information, and the conceptual information, as a logic model including CNF (conjunctive normal form) or DNF (disjunctive normal form).

Further, learning ability diagnostic apparatus 120 combines queries for some or all of properties for each chapter, each problem type, each difficulty level, and each learning feature to generate the wrong answer data.

Further, in the process of solving the equation, learning ability diagnostic apparatus 120 determines whether the values of the variables are constant for the solutions, and when the values of the variables are determined to be inconstant, it selects and transmits additional problem information for determining the values of the variables to terminal 100 and determines the values of the variables on the basis of additional answer data for the additional problem information received from terminal 100. Further, when there is a plurality of solutions, in the process of solving the equation, learning ability diagnostic apparatus 120 determines values that are constant for the solutions as the values of the variables of the logic equation with a plurality of solutions. Further, when the logic equation has one solution, in the process of solving the equation, learning ability diagnostic apparatus 120 determines the value of the single solution as the values of the variables of the logic equation. Further, when the logic equation has no solution, in the process of solving the equation, learning apparatus diagnostic apparatus 120 determines the values of the variables of the logic equation without a solution in accordance with whether the values directly extracted from the logic equation are constant.

On the other hand, learning ability diagnostic apparatus 120, as an apparatus for diagnosing ability such as for mathematics, extracts a test result for each level of diagnosis target for diagnosing the learning ability of a learner from the history of the test result of the learner. Exemplary diagnosis types include at least one of (i) diagnosing the degree of understanding the concept and skill of a specific chapter, (ii) diagnosing capability of a specific chapter, and (iii) diagnosing comprehensive learning ability. Diagnosing the degree of understanding the concept and skill of a specific chapter is to diagnose the degree of understanding the concept of each chapter and the skill for solving problems from test result of problems relating to the concepts and the skills. Diagnosing capability of a specific chapter is to find the solving ability for the problem types relating to chapters for each difficulty level in order to diagnose the learner's capability for each chapter. In addition, diagnosing comprehensive learning ability means diagnosis of learning properties such as comprehension ability, application ability, thinking ability, and ability of solving a problem, which are learning features relating the learning ability. The detailed structure and specification of learning ability diagnostic apparatus 120 are described later again.

Learning ability diagnostic apparatus 120 includes a database 120a for storing the problem type of a test problem, knowledge for solving the problem, the difficulty level and the skill type, as semantic modeling information. In other words, database 120a, as illustrated in FIG. 2, has a semantic structure of a problem for the structural and semantic information of a mathematic problem and the contents of the subject, which can be the body of the problem, is largely divided into two parts of a problem statement and a problem solution. Although the contents of a problem generally means only the problem statement, it is not limited thereto in the present embodiment and even solution of a problem, which includes solution, hints and notes of the problem, is included as a part of the contents of the problem.

The problem statement is a part that is provided for the learner to solve. A problem has a plurality of statement expressions. The reason is because the solution and the answer are completely the same but they are given in various ways when given to a learner. Different statement expressions make the learner feel different levels of difficulty, because it is relatively easy or difficult for the learner to understand the circumstances in the problem, depending on the statement expressions. Even if the statement expressions are different, the statement of the problem can be divided basically into a condition part, an action part, and a choice questionnaire. The condition part is a group of conditions given for the learner to be able to solve the problem and the action part is a part giving detailed instructions to do something. For example, the condition part is what is expressed such as ‘when ˜ is given’ or ‘if ˜’ and the action part is one that is expressed by ‘find ˜’ or ‘prove ˜’. For a geometrical problem, the condition part is configured by a picture partially or entirely, and for a data analysis problem, the condition part is configured by a table partially or entirely.

The problem has several items of solution because there are various ways of finding the answer of the problem. One item of solution of a problem is composed of steps for checking the circumstance of the problem, preparing for solving the problem, and solving the problem based on the foregoing steps. The steps may each have a plurality of substeps. The hint is considered as a subset of the solution and as being subordinating to the individual solution and exists in each step in solving the problem, having various forms such as a text, a expression, a picture, a table, a link to a relevant problem, and a link to other objects.

On the other hand, the semantic information of a problem includes information about the background of the problem, information about the problem statement, information about solving the problem and statistical information. The items of information other than the contents of a problem are called information about the background of the problem. The information about the background of a problem includes the nationality, the use, the school year or grade, the degree of importance, and the source. Mathematical problems are universal across the globe, but problems often cited in specific nations are given the country names. As for the uses, the use of a problem relates to what the learner solves the problem for. For example, the use is for general advancement, high school academic records and scholastic aptitude test. The grade is information about which grade learners usually solve the problem. The degree of importance determines problems that are necessarily learned and problems that are not, depending on problems. The degree of importance may be ‘necessary’ and ‘elective’. The source means the origin of a problem. For example, for a scholastic aptitude test problem, the information on what year the problem has been set in may be given as the source information.

There are main subject, context, keyword, key equation, and response type as the information determined as being related to the statement of a problem. The main subject is the information on which subject the problem is shown usually under, and as for the context, applied problems usually have specific contexts. For example, a given problem may be a mathematical problem that is shown usually in specific fields such as physics, biology, chemistry, finance and economy. The keyword means a keyword in the problem statement and the key expression means a key expression in the problem statement. Further, the response type is the format of making an answer paper, such as a multiple choice type, an objective form of answer, and a descriptive type.

The information determined as relating to solution of a problem includes the solution pattern, the solution type code, the cognitive area, the note, and the difficulty level. The solution pattern means the solution type of a problem and is given a solution type code as the value of a solution pattern property. The solution type code is obtained by compiling solution types of problems into a dictionary and giving codes to the solution types. The cognitive area has a property that a problem has in order to measure the proficiency of the cognitive area of a learner which is stated in learning theory. In general, there are ‘calculating ability’, ‘comprehension ability’, ‘analyzing ability’, ‘application ability’, and ‘problem solving ability’ in the cognitive area used in the mathematic field. The note means the items to be careful in solving a problem. Further, the difficulty level means the level of difficulty of a problem. The value of the property of the difficulty level may be tuned in accordance with the result of collecting statistics of the responses of learners.

The collected statistics result of the learners' responses means pieces of statistic information of the response result of the learners to a corresponding problem or exemplary uses of the problem. The pieces of information are not given in advance to a problem, but accumulated in the actual operation of the system. The rate of correct answers means the rate of finding actually correct answers, when learners answer a problem. It is a property regarding the difficulty level. A response time means the time that learners take to solve a problem on the average. The response time is also associated with the difficulty level. The frequency of use means the frequency of selection and use by learners. The frequency of setting up means a limited frequency of a corresponding problem set up for test by several external offices. The number of recommendation means the frequency of recommendations by learners.

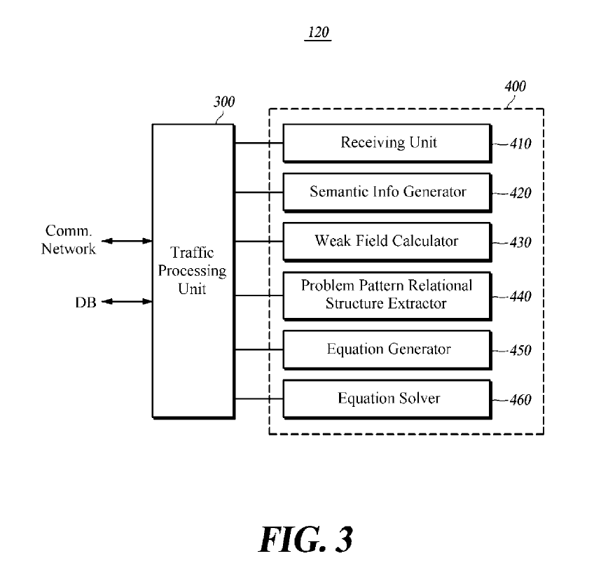

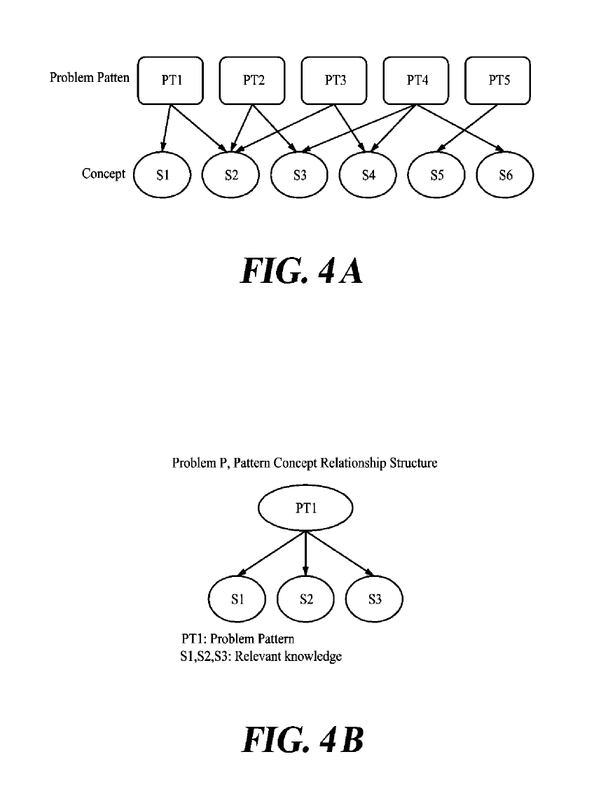

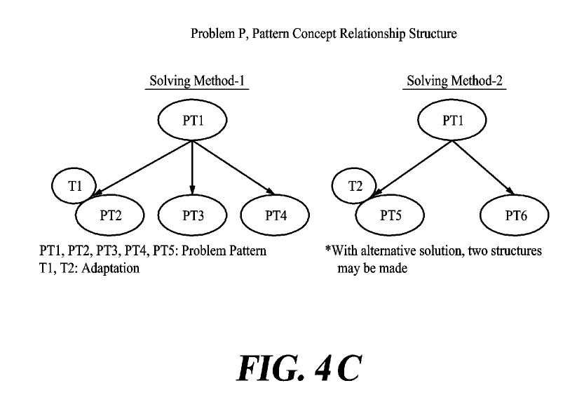

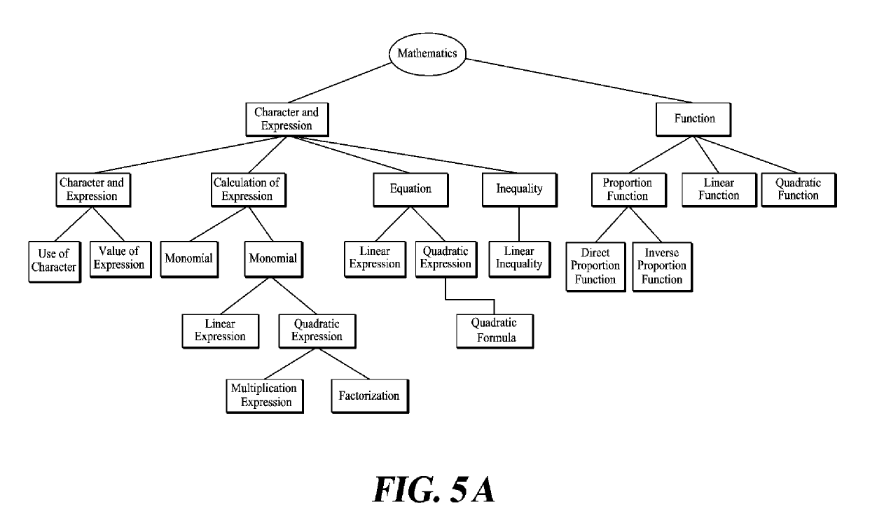

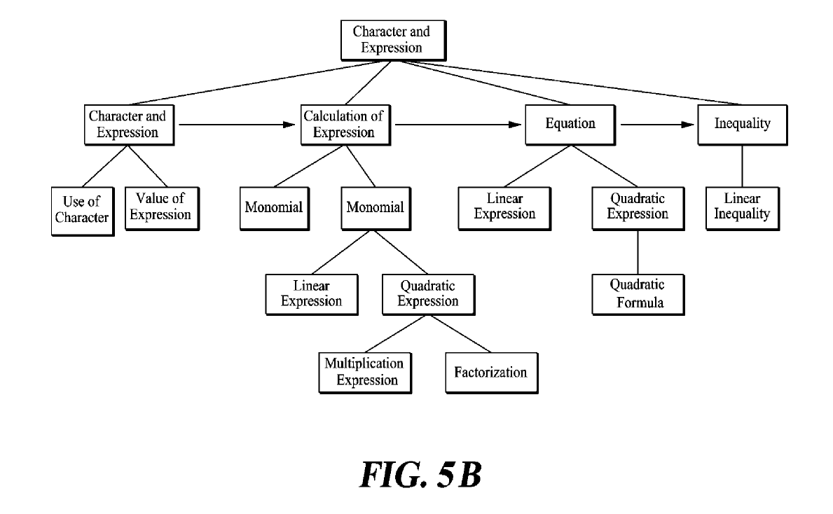

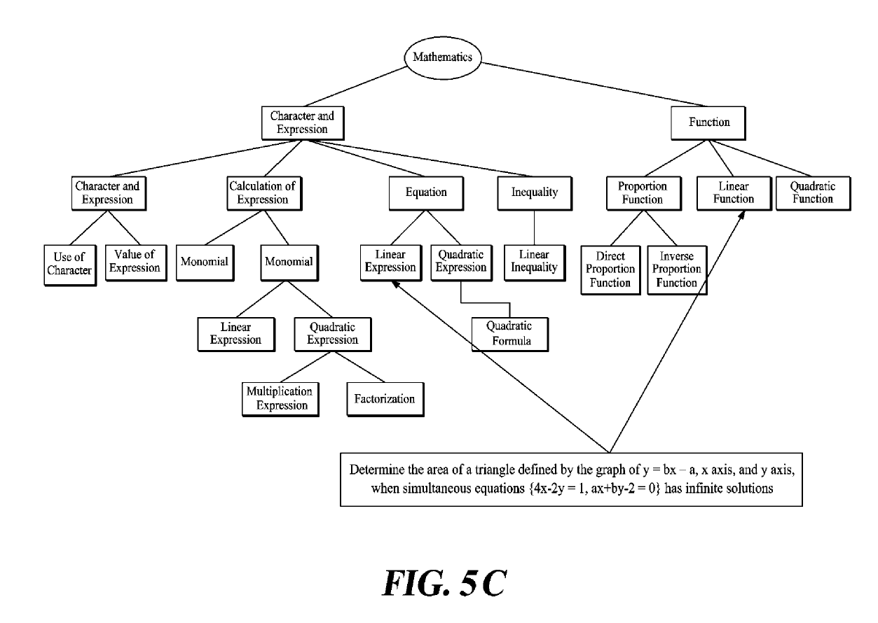

FIG. 3 is a schematic block diagram of an apparatus for diagnosing learning ability of FIG. 1, and FIGS. 4A to 4C are schematic diagrams for illustrating logic models generated by a problem pattern relational structure extractor of FIG. 3. FIG. 5A is a diagram of a tree structure of learning subjects, FIG. 5B is a diagram of a preceding process of the learning subjects, and FIG. 5C is a diagram of a relevance between a problem and topic.

As illustrated in FIG. 3, learning ability diagnostic apparatus 120 includes a traffic processing unit 300 and a diagnosing unit 400.

Traffic processing unit 300 includes a control unit (not shown) and an interface unit (not shown). The control unit controls whole signals or data that are processed by learning ability diagnostic apparatus 120 and the interface unit functions as an interface for interworking with communication network 110. In the process, the interface unit additionally performs a process, such as converting information. The control unit is implemented by one or more processors and/or application-specific integrated circuits (ASICs).

Diagnosing unit 400 includes a receiver 410, a semantic information generator 420, a weak field calculator 430, a problem pattern relational structure extractor 440, an equation generator 450, and an equation solver 460, in order to measure the learner's ability of understanding necessary concept for learning and problem-solving ability by type. Diagnosing unit 400 uses a diagnostic algorithm to diagnose the learning ability, for example, in mathematics.

Receiver 410 receives from terminal 100 chapter-related information or problem-related information that a learner wants to diagnose. Semantic information generator 420 generates semantic information with the structural information of problem information, having subject-specific problem information distinguished from the semantic information, for each piece of problem information included in the chapter-related information or the problem-related information.

Weak field calculator 430 receives answer data about the problem information from terminal 100, generates wrong answer data obtained by grading on the answer data, and calculates a weak field on the basis of the semantic information corresponding to the wrong answer data. Further, weak field calculator 430 combines queries for some or all of properties for each chapter, each problem type, each difficulty level and each learning feature to generate the wrong answer data obtained by grading on the answer data.

Further, weak field calculator 430 extracts a test result of a learner under the diagnosis target. The diagnosis target is diagnosis of the comprehension level of learning for each topic, diagnosis of ability of solving a problem, and diagnosis of learning features of a learner, and weak field calculator 430 extracts a necessary test result in accordance with the semantic information of a problem such as the problem pattern, the difficulty level, and the property. In other words, as the classified test type by diagnosis target for extracting a classified test result by diagnosis target for diagnosing learning ability of a learner from the test result history of the learner, there are diagnosis of the degree of understanding the basic concept of a specific chapter, diagnosis of the proficiency of a specific chapter, and diagnosis of comprehensive learning ability. The diagnosis of the degree of understanding the basic concept of a specific chapter diagnoses the level of understanding necessary concept for each chapter from a solution to a problem regarding the concept, the diagnosis of capability for a specific chapter find the solving ability for the problem types relating to chapters for each difficulty level in order to diagnose the learner's capability for each chapter, and the diagnosis of comprehensive learning ability diagnoses learning properties such as comprehension ability, application ability, thinking ability, and ability of solving a problem, which are learning features relating the learning ability.

As a method of extracting classified test results by diagnosis target, weak field calculator 430 determines the subject and method of the current diagnosis to perform in accordance with how much the learner has understood the concept of the current chapter from the current diagnosis history of the learner, how much the capability for each type of problems has been diagnosed, and how was the previous diagnosis result for the learning features. The test result can be extracted by combining queries such as the properties for each chapter, each type of problems, each difficulty level, and each learning feature.

For example, diagnosis of the degree of understanding the basic concept of a specific chapter can be expressed as in <Relational expression 1>.

(Topicεchapter) [symbol] (difficulty levelεlow) [symbol] (skill typeεall) <Relational expression 1>

Further, the diagnosis of proficiency in a specific chapter can determine after extracting the results for each difficulty level that the ability to solve a higher degree of problem warrants solving lower degrees of problems, which can be expressed as in <Relational expression 2> to <Relational expression 4>.

(Topicεchapter) [symbol] (difficulty levelεhigh) [symbol] (skill typeεall), <Relational expression 2>

(Topicεchapter) [symbol] (difficulty levelεmiddle) [symbol] (skill typeεall) <Relational expression 3>

(Topicεchapter) [symbol] (difficulty levelεlow) [symbol] (skill typeεall) <Relational expression 4>

The diagnosis of comprehensive learning ability is, for example, diagnosis of application ability in learning abilities, and can be expressed as in <Relational expression 5>.

(Topicεall) [symbol] (difficulty levelεall) [symbol] (skill typeεapplication ability) <Relational expression 5>

Problem pattern relational structure extractor 440 extracts problem pattern information that respective problem information pertains to, on the basis of the semantic information of the wrong answer data, extracts skill information or conceptual information for solution of the problem information, and then extracts the relationship between the extracted skill information and the extracted conceptual information therefrom. Further, problem pattern relational structure extractor 440 can show the relational structure of the problem pattern information, the skill information and the conceptual information with a logic model including CNF (conjunctive normal form) or DNF (disjunctive normal form).

Problem pattern relational structure extractor 440 reads out the structure information of problems (problems with dependency and precedence) relating to a chapter to diagnose, from the semantic information of the problems. Further, extractor 440 extracts the relational structure (pattern-topic bipartite graph) between the concept and the problem pattern, as in FIG. 4a, from the semantic information of a problem, extracts the relational structure (pattern-pattern graph) between problem patterns from the semantic information of the problems, and expresses the extracted relational structure between the problem pattern and the concept or between the problem patterns, with a logic model. For example, extractor 440 carries out conversion to a normalized model such as CNF (conjunctive normal form) or DNF (disjunctive normal form). To this end, problem pattern relational structure extractor 440 includes a logic model converter.

The properties of mathematic problems may be the problem type that the problems pertain to, knowledge needed for solution of the problems, the difficulty level, and the proficiency type. Referring to FIGS. 4B and 4C, the pattern type for classifying the problem types has the knowledge needed for the solution of problems as pattern concept relationship information and has the relationship to other problem types needed for the solution of problems as problem pattern relationship information. Further, the properties have switch information required between the problem pattern and the lower-rank problem pattern. The difficulty level is initially defined into high, middle, and low by a specialist and adjusted by a statistic method, and the proficiency type includes application, calculation, and understanding.

The relationship of problems that are extracted from the problem pattern relational structure extractor 440 is described in more detail with reference to FIGS. 5A to 5C. The extracted problems from the problem pattern relational structure extractor 440 is classified largely into the learning subject and topic and has the tree structure as in FIG. 5A. Describing the meanings of the learning subject and topic first, the learning subject is from categorizing the contents to be learned by a learner. The most fundamental unit in the contents to learn can be referred to and conditionally classified as a topic for having contents which are independent from the educational policies or the educational courses of each country. Therefore, the topic can be seen as an elemental learning subject which is not decomposed into plural learning subjects. Further, a group of several topics with a new name may be considered as a learning subject. Further, if several learning subjects can be grouped and given a new name, the entity can be also be called a learning subject. The name and topic of the learning subject can differ by definition and educational policy and educational course of the country. According to the definition as above, the learning subjects make up a tree structure as in FIG. 5A and the topics assume the leaf nodes of the tree, that is, the learning subject tree. The learning subject tree of FIG. 5A was constructed with reference to the educational course of mathematics for middle school in Korea (ROK). In FIG. 5A, there are learning subjects, ‘(quadric) multiplication expression” and ‘(quadric) factorization’, at the leaf nodes. The two learning subjects are considered as topics.

Referring to FIG. 5B, in order to learn one learning subject (hereafter, indicated by subj_1), it is sometimes necessary to previously learn another learning subject (hereafter, indicated by ‘subj_2). In this case, it is said that the learning subject subj_2 is a prerequisite for or precedes the learning subject subj_1. A plurality of learning subjects may precede one learning subject. FIG. 5B illustrates only the part corresponding to the learning subject ‘problem and expression’ in the tree structure of FIG. 5A. The preceding relationship of learning subjects is indicated by thin solid line arrows in the figure. In FIG. 5B, the learning subject ‘character and expression’ precedes the learning subject ‘calculation of expression’, ‘calculation of expression’ precedes ‘equation’, and the learning subject ‘equation’ precedes the learning subject ‘inequality’. The preceding relationship has transitiveness, such that it can be seen that the learning subject ‘character and expression’ precedes all of three learning subjects ‘calculation of expression’, ‘equation’ and ‘inequality’. Next, the relationship between a problem and a learning subject or topic is described with reference to FIG. 5C. A problem has a relation with a specific learning subject and there may be a plurality of related learning subjects. Once the relevance between a problem and a topic is given, the relevance with a higher-rank learning subject is correspondingly given. FIG. 5C illustrates the connection of learning subjects relating to a single problem. The problem has a relation with a learning subject ‘linear equation’ and a learning subject ‘linear function’ too.

Equation generator 450 generates a certain logic equation for solving a weak field. Equation generator 450 generates a logic equation on the basis of the relationship among problem pattern, the technical information and the conceptual information.

Further, equation generator 450 generates the simple state of knowing or unknowing a concept (topic) as a determination variable. In other words, a logic equation for diagnosis is established in accordance with the extracted problem and a learner's solution to the problem, and determination variables are differently generated depending on the diagnosis target. In order to diagnose the degree of understanding of the basic concept of a specific chapter, the determination variables are set up with the degree of understanding for concepts to know for each chapter from the pattern concept relationship of the problem type that the problem pertains to, and an equation is established. For example, assuming that a first problem pertains to problem pattern PT1 and the relating concept is composed of three factors S1, S2 and S3, the pattern concept relational structure illustrated in FIG. 4b can be constructed. In this case, an equation is generated in accordance with the test result, and when the problem was solved, S1·S2·S3=1 is satisfied, or when the problem was unsolved, S1·S2·S3=0 is satisfied.

In order to diagnose proficiency of a specific chapter, the determination variables are set up with the solving ability for the difficulty level at high, middle and low, of a problem pattern for determining mastery information with respect to the problem type from the problem pattern relational structure of the problem type that the problem pertains to, and an equation is established. For example, it is assumed that the first problem pertains to problem pattern PT1 and there are two methods of problem solving. Assuming that the first solution for PT1 needs translation of T1 and needs solving ability for the problem types of PT2, PT3 and PT4, the first solution, as illustrated in FIG. 4C, is expressed as solution-1 and is expressed as solution-2 when it needs translation T2 as an alternative solution for solving PT1 and solving ability for problem types PT5, PT6 and the like. In this case, an equation is generated in accordance with the test result, and when there is an alternative solution, it has a DNF (disjunctive normal form) type of equation. T1·PT2·PT3·PT4+T2·PT5·PT6=1 is satisfied when the problem is solved, and T1·PT2·PT3·PT4+T2·PT5·PT6=0, when the problem is unsolved.

Equation solver 460 transmits the resultant solution of the logic equation to terminal 100. Further, when the logic equation has a plurality of solutions, equation solver 460 determines whether the values of the variables are constant for the solutions, and when the values of the variables are determined to be inconstant, it selects and transmits additional problem information for determining the values of the variables to terminal 100 and determines the values of the variables on the basis of additional answer data for the additional problem information received from terminal 100. Further, when there is a plurality of solutions, equation solver 460 determines values that are constant for the solutions as the values of the variables of the logic equation with a plurality of solutions. Further, when the logic equation has a single solution, equation solver 460 determines the value of the single solution as the values of the variables of the logic equation. Further, when the logic equation has no solution, equation solver 460 determines the values of the variables of the solutionless logic equation depending on whether there is consistency or not with the values extracted directly from the logic equation.

Equation solver 460 can determine whether there is a solution in the process of solving the logic equation, and if yes, can determine whether there is only one solution or there are several solutions. Further, when there are several solutions, equation solver 460 can additionally determine whether the variables are constant for the solutions, and determine the values of the variables by applying undecided variable solution by problem addition for the inconstant variables. In contrast, when there is no solution, a counting methodology may be applied as a rule-based method of determining variables for the inconstant determination variables.

In more detail, when there is only one solution satisfying the logic equation, the values of the variables are each determined as a unique value. When there are several solutions satisfying the logic equation, the values of the variables, which are constant for the multiple solutions, are determined as the values of the variables. Further, when the value of specific variable is inconstant, that is, when the learner is staggering between right and wrong answers to the problem, an additional problem suitable for determining the variable is selected and set to the learner to receive the resultant value and determine the undecided variable. Further, there are repeats of a process for selecting and setting the additional problem suitable for the undecided variable, followed by re-diagnosing at a limited number of times or in a limited time.

If there is no solution satisfying the logic equation, when a value can be directly extracted from the logic equation, the value of the determination variable is determined. When the value of the determination variable is not consistent, the number of occurrences of the inconsistent values is recorded. For example, the numbers are recorded of respective variables that are valued 1 and 0. Further, when the value of the determination variable is inconsistent, the values of the variables are determined in accordance with a rule-based variable determination methodology from the recent history and the information on the number of times recorded from the current result. On the other hand, the process of solving the logic equation is repeatedly performed on the remaining equations, which are generated by substituting the determined variables.

As the method of solving the logic equation, various methods may be used, such as SAT (satisfiability problem) solver. According to the present embodiment, although it is possible to apply a common SAT itself to the logic equation to calculate in diagnosing, it may also be possible to construct and use a new type of algorithm including SAT. The first reason is because there is every possibility that there is no solution satisfying simultaneous equations. A learner may answer wrong and correct for the problems pertaining to a specific problem type, when solving a logic equation. The learner may not know the exact concept or may make a mistake with calculation. There is every possibility that an inconsistent result turns out, in the test result. There would be no solution for the inconsistent simultaneous equations. In this case, it may be possible to use the number of times that various values turn out as data for applying a variable value setting methodology based on rules for inducing a conclusion by simply counting the number of times without directly determining the values of the inconsistent determination variables. The numbers of times are recorded, for example, the case when the value of a variable X is 1 (TRUE) is three times and the case when it is O (FALSE) is four times. Further, it may be possible to apply a variable value setting methodology based on rules to inconsistent variables. For example, when the value of a variable X was recently 2 by 80% or more, the value of X can be determined as 1. The second reason is because there may be countless solutions, when the number of variables to determine is smaller than that of equations. In this case, it is possible to determine the variables only when the test result for an additional problem that can determine the values is additionally inputted.

The order of solving an equation is as follows. \textcircled{1} Determine whether there the logic equation has a solution, using a calculator. \textcircled{2} Record the unique solution as the result value, if there the equation has the unique solution. \textcircled{3} Perform the following processing if the equation has no solution. First, count and record the number of cases when the variable has 0 and 1 by applying a counting methodology to the inconsistent and undecided variable. Second, apply the methodology only when it is possible to calculate the value directly from a single equation. As an example, increase the count of the value 1 (TRUE) of S1, S2, and S3 one by one for S1·S2·S3=1. As a second example, increase the count of the value 0 (TRUE) of S1, S2, and S3 one by one for S1+S2+S3=0. As a third example, it is impossible to determine the value of S2 and S3, for S2·S3=0, S2+S3=1. In this case, the processing uses the remaining equation. Third, repeat the process from \textcircled{1} for the remaining equation except for the counted equations. \textcircled{4} Perform the following processing, when the equation has several solutions. First, determine whether the variables are constant for several solutions. Second, set the constant values as the values of the variables, for the constant values. Apply ‘undecided variable solution by problem addition’ to the variables with inconstant values. The undecided variable solution by problem addition, a methodology that determines the values of the variables by adding a problem when it is impossible to determine the values of the variables, calculates the number of the suitable or minimum additional problems for the undecided variable solution and repeats the process of determining the undecided variables using the additional problem.

For example, assuming that seven solutions were obtained from solution of a logic equation, as in <Table 1>, when determining whether a learner know or does not know X1, X2, X3, X4, . . . , Xh about a specific subject, using 1 or 0,

TABLE 1

| | X₁ | X₂ | X₃ | X₄ | . . . | Xₕ |
|---|---|---|---|---|---|---|
| Sol. 1 | 1 | 1 | 0 | 0 | | 1 |
| Sol. 2 | 1 | 1 | 0 | 1 | | 1 |
| Sol. 3 | 1 | 1 | 0 | 1 | | 0 |
| Sol. 4 | 0 | 1 | 1 | 0 | | 0 |
| Sol. 5 | 0 | 0 | 0 | 0 | | 0 |
| Sol. 6 | 0 | 0 | 0 | 1 | | 0 |
| Sol. 7 | 0 | 1 | 1 | 0 | | 0 |

When the result of a learner is obtained by setting an additional problem determining X1, the value of X1 is 1 when the learner gives a correct answer, so the available solutions in the seven solutions reduce to three of Solution 1, Solution 2, and Solution 3. Further, as X1 is determined as 1, the value of X2 is determined as 1 and the value of X3 is determined as 0.

Those to additionally determine reduce as in <Table 2>. The selection of an additional problem and determination of a variable are repeated on <Table 2>.

TABLE 2

| X₄ | . . . | Xₕ |
|---|---|---|
| 0 | | 1 |
| 1 | | 1 |
| 1 | | 0 |

The variable value setting methodology based on rules is applied to the inconsistent variables. As examples of the methodology based on rules, there are a method of determining how much the learner know or does not know a specific pattern of problem from the result of solving the current and past problems, a method of determining whether the learner can solve a specific pattern of problem from the result of past diagnosis and the result of solving the current problem, a method of determining setting a policy rule for determination, a method of carrying out determination in accordance with a time series methodology, a setting method according to the setting of a threshold, and a method of carrying out determination by giving a weight more than the lower-rank pattern, when the learner solved a higher-rank pattern of problem.

The following example is about the process of solving the above equation, providing the configuration and solution of a logic equation.

First, the configuration of a logic equation from the structure of a problem and the test result can be expressed as <Relational expression 6> and <Relational expression 7>.

P1<<S1·S2(CNF),

P2<<S2·S3·S4·S5(CNF),

P3<<S2+S3(DNF),

P4<<S4·S6(CNF) <Relational expression 6>

Ans(P1)=T,

Ans(P2)=F,

Ans(P3)=F,

Ans(P4)=F <Relational expression 7>

The linear solutions of the logic equation induced from <Relational expression 6> and <Relational expression 7> can be expressed as <Relational expression 8> and <Relational expression 9>.

From P1, S1=1, S2=1,

From P2, S2·S3·S4·S5=0,

From P3, S2=0, S3=0,

From P4, S4·S6=0 <Relational expression 8>

Further, the number of times of the values of the inconsistent variables calculated from <Relational expression 8> is as <Relational expression 9>.

S1=1(#1),

S2=1(#1), 0(#1),

S3=0(#1) <Relational expression 9>

The result of determining the values of the variables based on the rules from <Relational expression 9> is determined as S2=1, S3=0.

The remaining equations are shown in <Relational expression 10>.

S2·S3·S4·S5=0,

S4·S6=0 <Relational expression 10>

Assuming that S2 or S2 cannot be determined from the current test result,

The test result after generating an additional problem for determining undecided variables is inputted as in <Relational expression 11>.

S4=1, S5=0 <Relational expression 11>

The result of regeneration from the result of addition is as <Relational expression 12>.

S4=1, S5=0, S6=0 <Relational expression 12>

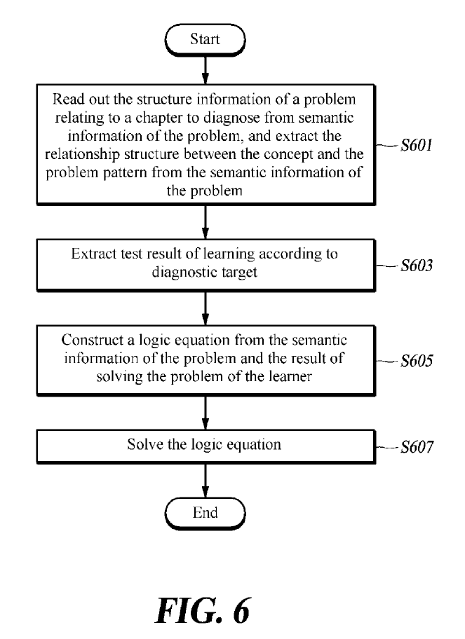

FIG. 6 is flowchart of illustrating method for a learning ability diagnostic process of a learning ability diagnostic apparatus of FIG. 1.

Referring to FIG. 6 together with FIG. 1, learning ability diagnostic apparatus 120 reads out the structure information of a problem relating to a chapter to diagnose, from semantic information, and extracts the relational structure between the concept and the problem pattern from the semantic information of the problem (S601). According to this process, if a learner accesses learning ability diagnostic apparatus 120 and provides the information on the chapter to diagnose, learning ability diagnostic apparatus 120 extracts the relational structure, by way of using the relating information and semantic information. In this process, learning ability diagnostic apparatus 120 additionally performs the process of converting the relational structure between the extracted problem pattern and the concept or between the problem patterns into a normalized model such as CNF or DNF in order to express the relational structure into a logic model.

Then, learning ability diagnostic apparatus 120 extracts the test result of the learner according to the diagnosis target (S603). Learning ability diagnostic apparatus 120 extracts the classified test result by diagnosis target for diagnosing the learning ability of the learner from the history of the result of tests that the learner has taken, in which the extracted types are classified test types by diagnosis target, including diagnosis on the information about understanding of the basic concept of a specific chapter, diagnosis on proficiency for a specific chapter, and diagnosis on comprehensive learning ability. Learning ability diagnostic apparatus 120 uses a combination of queries to extracts the classified test result by diagnosis target.

Further, learning ability diagnostic apparatus 120 formulates a logic equation from the semantic information of the problem and the result of solving the problem of the learner (S605). In other words, diagnostic apparatus 120 constructs a logic equation for diagnosis in accordance with the extracted problem and the result of solving the problem by the learner, configuring the simple state of knowing or unknowing about the concept as the determination variable in making the logic equation. For example, the case of solving the problem can be assigned 1 and the case of unsolving the problem 0. The related details were sufficiently described above, so it is no longer described.

Further, learning ability diagnostic apparatus 120 carries out a process of solving the logic equation (S607). The method of solving the logic equation uses an SAT solver or a new algorithm with the SAT solver improved.

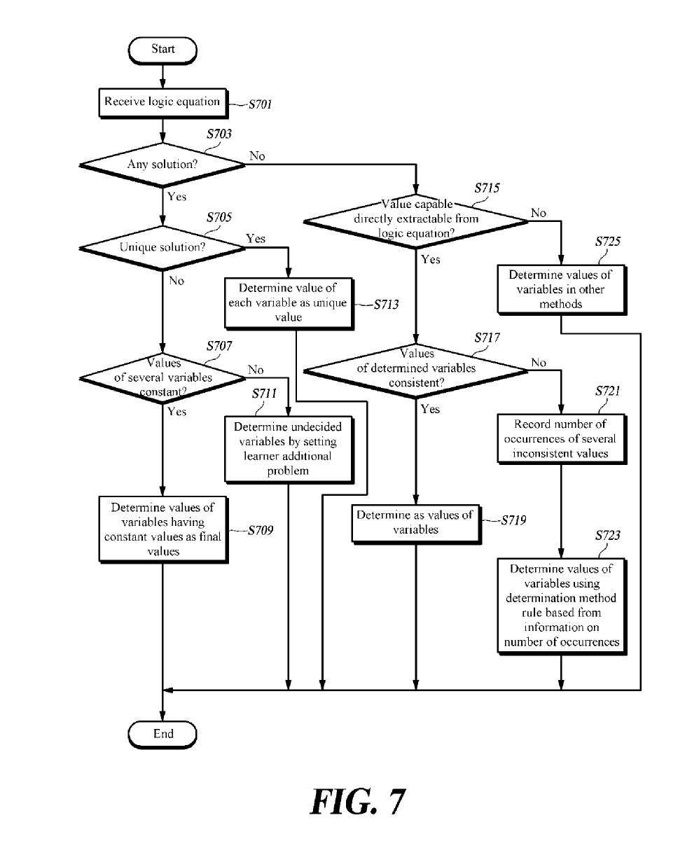

FIG. 7 is a detailed flowchart of the equation solving process of FIG. 6.

Describing simply the process of solving an equation with reference to FIG. 7 together with FIGS. 1 and 3, equation solver 460 of learning ability diagnostic apparatus 120 can receive the logic equation made by equation generator 450 under the control of traffic processing unit 300 to calculate the logic equation (S701).

Further, diagnostic apparatus 120 determines whether there is a solution by solving the logic equation (S703), determines whether there is a unique solution if there is a solution (S705), and further determines whether the values of the variables are constant, when there are several solutions (S707).

When the values are constant, diagnostic apparatus 120 determines the values of the variables as final values (S709).

However, when the values of the variables for the solutions are not constant in S707, diagnostic apparatus 120 sets the learner an additional problem and determines the undecided variables from the result values (S711).

Further, when there is a unique solution in S705, diagnostic apparatus 120 determines the values of the variables as unique values (S713).

On the other hand, when there is no solution in S703, diagnostic apparatus 120 determines whether values can be extracted directly from the corresponding logic equation, and when they can't be diagnostic apparatus 120 can determine the values of the variables, using other methods (S725), and end the process.

In contrast, when the values can be extracted, diagnostic apparatus 120 determines whether the values of the additional determination variable are consistent (S717), and when they are consistent, it determines the relating values as the values of the variables (S719).

If they are inconsistent in S717, diagnostic apparatus 120 records the number of times of the inconsistent values (S721) and determines the values of the variables in accordance with the variable determination method based on rules from the information about the number of times (S723).

The details about the steps illustrated in FIG. 7 were sufficiently described above with reference to FIGS. 1 to 6 for one to reference and they will not be repeated.

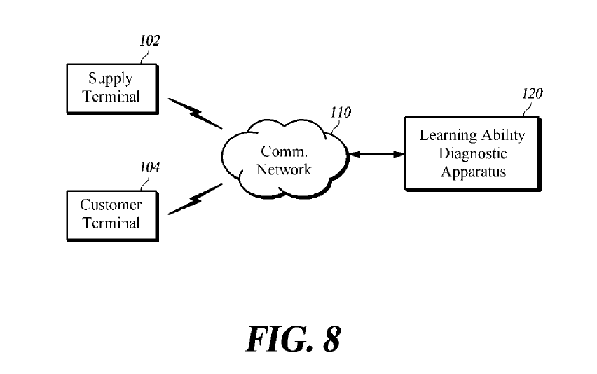

FIG. 8 is a schematic block diagram of a learning ability diagnostic apparatus according to at least one embodiment which provides a learning market.

A system for providing a learning market according to the present embodiment includes a supply terminal 102, a consumer terminal 104, a communication network 110, and a learning ability diagnostic apparatus 120. Meanwhile, although the system for a learning ability diagnostic apparatus to provide a learning market includes only supply terminal 102, consumer terminal 104, the communication network 110, and learning ability diagnostic apparatus 120 in the present embodiment, this is only an example of the idea of the present embodiment and the components of the system for providing a learning market are changed and modified in various ways by those skilled in the art without departing from the scope of the present embodiment.

Further, the learning market described in the present embodiment, as a kind of application stores, may be provided by network operators, but it is not limited thereto. That is, a specific browser (access application) that can access a learning market is necessary to drive the learning market and it is possible to access the corresponding learning market by driving a corresponding browser.

Supply terminal 102 and consumer terminal 104 mean devices responsive to a learner's key operations or commands for transmitting/receiving various data through communication network 110, and may be one of a tablet PC, laptop computer, personal computer or PC, smartphone, personal digital assistant or PDA and mobile communication terminal. In other words, supply terminal 102 and consumer terminal 104 mean memories for storing browsers and programs for accessing learning ability diagnostic apparatus 120 via communication network 110, and a microprocessor for executing the relevant programs to effect operations and controls. To be more specific, the terminal is typically the personal computer. That is, supply terminal 102 and consumer terminal 104 is any devices if they are connected to communication network 110 and can perform server-client communication with learning ability diagnostic apparatus 102, including all of communication computing devices such as a notebook, a mobile communication device, and a PDA. Further, supply terminal 102 and consumer terminal 104 is equipped with a touch screen, but they are not limited thereto.

Although supply terminal 102 and consumer terminal 104 are implemented separately from learning ability diagnostic apparatus 120 in the present disclosure, they may be implemented as stand-along devices, including learning ability diagnostic apparatus 120, in actually implementing the present disclosure.

Supply terminal 102 requests learning ability diagnostic apparatus 120 to register a production of learning contents in order to register the learning contents on a learning market and inputs the basic information on the learning contents by accessing learning ability diagnostic apparatus 120. Consumer terminal 104 receives the information on purchase of the learning contents from learning ability diagnostic apparatus 120 and purchases the learning contents for selling or learning. That is, the learning contents selected to be purchased by consumer terminal 104 is discriminately put in a shopping cart or a learning cart. The shopping cart and the learning cart are as those in [Table 3].

TABLE 3

| | Object | | |
|---|---|---|---|
| Item | of use | Transaction | Note |
| Shopping | Selling | Permitted | All users approved as nonlearning |
| Cart | | | market participants are granted a |
| | | | shopping cart and transaction |
| | | | activities. |
| Learning | Learning | Non- | To commercially repurpose math |
| Cart | | permitted | learning contents in the learning |
| | | | carts, the user converts the learn- |
| | | | ing cart into shopping cart and gets |
| | | | an approval to be the nonlearning |
| | | | market participant before entering |
| | | | the transactions. |

That is, consumer terminal 104 can access learning ability diagnostic apparatus 120, using an ID for sale or an ID for learning. When a learner uses consumer terminal 104 for learning, the learner can login learning ability diagnostic apparatus 120, using the ID for learning, and when the object is sale, the learner can login learning ability diagnostic apparatus 120 using the ID for learning. The ID for sale or the ID for learning may be given by only one to one learner.

Meanwhile, consumer terminal 104 receives learning contents made by supply terminal 102, carries out review to register the received learning contents on the learning market, giving the learning contents semantic information on the basis of the received basic information from supply terminal 102 and then registers the learning contents on the learning market, transmits the information on purchase of the learning contents to another terminal accessing the learning market, and sells the learning contents for sale or learning, when there is a request for purchasing in the information on purchase. Meanwhile, the learning contents received by consumer terminal 104 includes an application downloaded from a learning market, which is an application stores in smartphones, and includes a VM (virtual machine) and an application downloaded from the server of a mobile operator in feature phones.

Communication network 110 is a network that can transmit/receive data to/from an internet protocol, using various wire/wireless communication technologies such as an internet network, an intranet network, a mobile communication network, and a satellite communication network. Communication network 110, a network connecting learning ability diagnostic apparatus 120, supply terminal 102, and consumer terminal 104, is a closed-type network such as LAN (local area network) or WAN (wide area network), but is preferable an open type such as the internet. The internet means a global open type computer network structure that provides a TCP/IP protocol and various services in an upper hierarchy, that is, HTTP (HyperText transfer protocol), Telnet, FTP (file transfer protocol), DNS (domain name system), SMTP (simple mail transfer protocol), SNMP (simple network management protocol), NFS (network file service), and NIS (network information service). The technology relating to communication network 110 has been known in the art and the detailed description is not provided.

Learning ability diagnostic apparatus 120 has a configuration the same as a common web server or a network server. However, for software, it includes a program module that is implemented by any languages such as C, C++, Java, Visual Basic, and Visual C. Learning ability diagnostic apparatus 120 is implemented in the type of a web server or a network server and the web server means a computer system is generally connected with a plurality of non-specific clients and/or other servers through an open type of computer network such as the internet, receives requests for perform works from the clients of another web server, and induces and provides the results of the work, and computer software (web server program) installed for the computer system. However, it should be understood as a side concept including, other than the web server program described above, a series of application program operating on an web server and various databases constructed inside, in some cases.

Learning ability diagnostic apparatus 120 is implemented by web server programs that are provided in various ways in common hardware for a server, depending on the operating system such as DOS, Windows, Linux, UNIX, and Macintosh, and typically, there are Website and IIS (Internet Information Server) used under the Windows environment, and CERN, NCSA, and APPACH used under the UNIX environment. Further, learning ability diagnostic apparatus 120 cooperates with an authentication system and a settlement system for providing learning content. Further, learning ability diagnostic apparatus 120 classifies, stores, and manages the members' information and the database is provided inside or outside learning ability diagnostic apparatus 120. The database means a common data structure implemented in a storage space (hard disk or memory) of a computer system, using a DBMS, meaning the data storage format that can freely search (extract), delete, edit, and add data, is implemented to fit to the object of the present embodiment, using an RDBMS such as Oracle, Informix, Sybase, and DB2, an OODBMS such as Gemston, Orion, and O2, and XML Native Dadabase such as Excelon, Tamino, and Sekiju, and has an appropriate field or elements to achieve its function.

Learning ability diagnostic apparatus 120 receives a production of learning contents from supply terminal 102. Although learning contents includes language learning content, mathematical learning content, foreign language learning content, and social/science research learning content, preferably, the learning contents may be mathematical contents including expression information and text information in Math ML format, but not limited thereto. Further, the mathematical contents may include mathematical problem, mathematical learning data, learning management tools, and mentors and the details are as in [Table 4].

TABLE 4

| Items | | Detail |
|---|---|---|
| Math | Math problem | Math problem |
| problem | Math problem | Solving mathematical problem, solution |
| | solution | video, etc. |
| Math | Lecture video | Video lecture such as VOD |
| learning | e-Book | |
| data | Document | Text or image with format of doc, hwp, |
| | | ppt and pdf |
| Learning | Leaning | |
| manage- | management | |
| ment | system (LMS) | |
| tool | Learning | |
| | contents | |
| | management | |
| | system (LCMS) | |
| Mentor | Learning | Person who helps learning and responses |
| | assistant | questions or provides management, coun- |
| | | cil for learning, council for the next stage |
| | | of education, and cooperative learning |
| | Teacher, | Person who teaches mathematics |
| | instructor | |
| Others | Designer of | Person who constructs a learning program |
| | learning | for a specific set or group of learners or |
| | course | makes a new learning program under |
| | (program) | educational institutes |
| | Learning | Learning plan designed to meet the learn- |
| | course | ing object on the basis of learning con- |
| | (program/ | tents optimized and extracted for learners |
| | tamplet) | |

Learning ability diagnostic apparatus 120 carries out review to register the learning contents on a learning market. Learning ability diagnostic apparatus 120 reviews the learning contents on the basis of at least one of the information about possibility of carrying the learning contents and the information on checking errors. Learning ability diagnostic apparatus 120 checks whether contents the same as the learning contents requested to be registered is found in the contents registered already in the learning market, and when the same contents are found as the result of checking, it transmits a message saying ‘unsuitable’ for rejecting the learning contents requested to be registered to the supply terminal. Learning ability diagnostic apparatus 120 checks similarity to the contents registered already, when there are no contents the same as the contents registered already, and when the checked similarity is less than a predetermined value, it registers the learning contents requested to be registered on the learning market. Learning ability diagnostic apparatus 120 checks similarity between the text information or the expression information included in the learning contents registered already and the text information and the expression information included in the learning content, on the basis of matching ratio. Learning ability diagnostic apparatus 120 inactivates the contents that are the same and recorded more than a predetermined number by the consumer terminal, in the learning contents registered on the learning market. The learning market includes one or more of a general market, a sale market, and a learning market. The learning market is as in [Table 5].

TABLE 5

| Type | Detail |
|---|---|
| General | Market for selling mathematic learning contents such as |
| market | problem, learning data, and learning course |
| Sales | Market for opening a lecture in the provided LMS or |
| market | having the function of an on-line institute to provide |
| | mathematic learning contents purchased from a general |
| | market by a tutor (teacher/instructor) or contents made |
| | by an individual |
| Learning | Market opened for community learning (cooperative learn- |
| market | ing) between learning assistant or learners to reply to |
| | consumer/provider with expert knowledge in specific fields |

Learning ability diagnostic apparatus 120 gives the learning contents semantic information on the basis of the basic information received from supply terminal 102 and then registers the learning contents on the learning market, when finishing authenticating the learning contents through review. Learning ability diagnostic apparatus 120 shares the learning contents registered on the learning market with an SNS (social network service) server and a server that supports searching which include one or more of Blog, Twitter, Facebook, homepage, and mini homepage. Learning ability diagnostic apparatus 120 selects and gives, as semantic information, information with high relevance to the basic information in the information with high similarity or identity in learning meaning determined on the basis of the basic information. The basic information includes one or more of the title information, the explanation information, the image information, and the keyword information of the learning content.

Learning ability diagnostic apparatus 120 transmits the information on purchase of the learning contents to consumer terminal 104 accessing the learning market 104. Learning ability diagnostic apparatus 120 transmits the information on purchase of the learning contents with the basic information matching with the information on a search word inputted through a search server from consumer terminal 104. Learning ability diagnostic apparatus 120 finds out the relationship between the search word and the learning content, using inferring rules applied on the basis of the Ontology information corresponding to the search word information, and then transmits the information on purchase corresponding to the relationship to consumer terminal 104.

Learning ability diagnostic apparatus 120 sells the learning contents for sale or learning, when there is a request for purchase in the information on purchase. Learning ability diagnostic apparatus 120 provides tools for editing and making for the learning contents to consumer terminal 104 that purchased the learning content, and permits secondary sale of learning contents edited by the tools for editing and making, when the learning contents is sold for learning. The semantic information has a data structure including a background part including one or more of the information on the learner's nation, the information of the learner's object, the information of the learner's grade, the information of importance of the learner, and the information of the origin of the learner, a statement part including one or more of the information on the main subject of learning, the information on the learning circumstances, the information of keyword of learning, and the information on the format of the key-expression of learning, a solution part including one or more of the information on the learning solution pattern, the information on the cognitive field in learning, the information on notice in learning, and the information on the difficulty level of learning, and a statistic part including one or more of the information on the correct ratio in learning, the information on the frequency in use of learning, the information of frequency of setting in learning, the information of the number of recommendations, and the information on the response time.

Learning ability diagnostic apparatus 120 generates diagnosis test information in accordance with the information of learning result of the learning contents received from the consumer terminal and stores the diagnosis test information, when the learning contents are sold for learning. Learning ability diagnostic apparatus 120 receives answer data corresponding to the learning test data from consumer terminal 104 and transmits the data resulting from batch mode diagnosis test or interactive mode diagnosis test on the basis of checking the answer data to consumer terminal 104, when learning test data is included in the learning content. The details of the batch mode diagnosis test or the interactive mode diagnosis test are as in [Table 6].

TABLE 6

| Diagnosis | |
|---|---|
| test method | Detail |
| Batch mode | General diagnosis test, level diagnosis test |
| diagnosis test | Learning ability is diagnosed by setting several |
| | problems |
| Interactive mode | Interactive learning |
| diagnosis test | Learning ability is diagnosed and improved by |
| | repeatedly proposing a problem on the basis of |
| | semantic models for problem-based learning |
| | such as a hint, solution, the difficulty level, |
| | in accordance with the circumstances and re- |
| | sponse of the learner by sending one problem. |

In Table 6, the learning result information includes one or more of the information of the number of times of downloading the learning content, the information on the number of times of driving the learning content, and the information on learning achievement. The details of the learning result information are as in [Table 7].

TABLE 7

| Value eval- | |
|---|---|
| uation method | Detail |
| Number of | Number of times of downloading to a cart (number |
| downloading | of purchasing times) |
| times | Differentiated value test reference is applied to |
| | shopping cart and learning cart even for the same |
| | number of downloading times |
| Number of | Number of times of uses in learning after purchasing |
| times of | Provided through learning tracking information |
| actual uses | For evaluating excellent learning contents with |
| for learning | high frequency of uses, when the same contents |
| | purchased one time are used for learning several |
| | times |
| Learning | Measured improvement of learning achievement is |
| achievement | checked after using for learning |
| coefficient | Learning achievement test coefficient |

Learning ability diagnostic apparatus 120 the recommendation information received from consumer terminal 104. The recommendation information includes one or more of learning data recommendation information, learning problem recommendation information, mentor recommendation information, and learning template recommendation information. The details of the recommendation information are as in [Table 8].

TABLE 8

| Elements for | |
|---|---|
| recommen- | |
| dation | Details |
| Learning | Learning data optimized to a learner is recommended, |
| data | when necessity of memorizing learning data is proposed |
| recommen- | as a result of diagnosis |
| dation | Appropriate learning data is selected and recommended |
| | after repeat learning or intensive learning is determined |
| | judging from the diagnosis result |
| Learning | Problem optimized to a learner is recommended, when |
| problem | necessity of solving various problems is proposed as |
| recommen- | a result of diagnosis |
| dation | Appropriate learning problem is selected and recom- |
| | mended after repeat learning or intensive learning is |
| | determined judging from the diagnosis result |
| | Appropriate contents are recommended after a learning |
| | plan is established in accordance with the learning |
| | circumstances of a learner determined as a result of |
| | diagnosis |
| Mentor | Mentor optimized to a learner is recommended when |
| recommen- | necessity of a mentor for learning is proposed in |
| dation | accordance with the result of diagnosis |
| | Mentor means a tutor, a manager for learning (parents, |
| | teacher), learning community and counselor for the |
| | next stage of education |
| Learning | Learning course optimized to a learner is proposed |
| template | in accordance with the result of diagnosis |
| (course/ | Learning template selected by a learner in learning |
| program) | is mapped and proposed again as a learning template |
| recommen- | optimized to the learner in accordance with the |
| dation | result of diagnosis |

Meanwhile, the terms used in another embodiment are as those in [Table 9].

TABLE 9

| | Class of | Function | |
|---|---|---|---|
| Item | function | in market | Detail |
| User | Provider | Content | Person to create math learning contents or produces learning |
| | or maker | producer | contents from existing contents |
| | | Primary | Person to distribute contents as a producer |
| | | seller | |
| | | Secondary | Person who purchases contents from a primary seller and then |
| | | seller | integrates and resells the contents to be suitable for specific |
| | | | learning subjects, further establishing an on-line institution or |
| | | | opening a lecture after purchasing the contents |
| | | Mentor | 1. Who is a person providing learning mentoring and helps a |
| | | | learner to answer various questions generated in learning and |
| | | | make a learning plan |
| | | | 2. Who functions as a learning assistant for giving an advice |
| | | | of a secret method of learning, which cannot be given by a |
| | | | school and an institute, and improves actual learning ability |
| | | | 3. Who gives learning know-how and general advices for |
| | | | college entrance examination with career coaching and helps |
| | | | forming habits in study and making a strategic learning plan |
| | | | 4. Who provides a learning management service for managing |
| | | | the entire learning activity and serves learners with an |
| | | | optional visit mentoring and tele-mentoring for convenience |
| | | Tutor | Learning instructor (teacher and instructor) |
| | Customer | Learner | Who desires to learn with the use of math learning contents |
| | or Consumer | Mentor | 1. Who is a person providing learning mentoring and helps a |
| | | | learner to answer various questions generated in learning and |
| | | | make a learning plan |
| | | | 2. Who functions as a learning assistant for giving an advice |
| | | | of a secret method of learning, which cannot be given by a |
| | | | school and an institute, and improves actual learning ability |
| | | | 3. Who gives learning know-how and general advices for |
| | | | college entrance examination with career coaching and helps |
| | | | forming habits in study and making a strategic learning plan |
| | | | 4. Who provides a learning management service for managing |
| | | | the entire learning activity and serves learners with an |
| | | | optional visit mentoring and tele-mentoring for convenience |
| | | Tutor | Learning instructor (teacher and instructor) |
| | | Secondary | Person who purchases contents from a primary seller and then |
| | | seller | integrates and resells the contents to be suitable for specific |
| | | | learning subjects, further establishing an on-line institution or |
| | | | opening a lecture after purchasing the contents |
| System or | Algorithm | Evaluation | Evaluates mathematic learning contents and provides the |
| Platform | | processor | value in real time in various ways |
| | | Diagnosis, | Diagnoses the degree of skill of learning ability and learning |
| | | test | achievement of a learner from the learning result through a |
| | | processor | problem learning method. |
| | | | Provides a diagnosis result on the basis of the current |
| | | | proficiency, the past learning and achievement history of a |
| | | | learner. |
| | | Recomm. | Recommends custom-fit learning contents optimized to a |
| | | processor | learner by analyzing the diagnosis test result |
| | | Semantic | Gives semantic information for searching information with |
| | | generation | high accuracy by determining similarity and identity in |
| | | processor | mathematical meaning on the basis of basic information and |
| | | (giving | selecting knowledge with the highest relevance. |
| | | semantic) | Gives semantic information composed of modules for |
| | | | generating, managing, and storing ontology and having a |
| | | | mathematical meaning. |
| | | Determin. | Whether contents are similar is determined by a method of |
| | | of | measuring the distance between the contents (or matrix |
| | | similarity | measuring method) on the basis of a semantic model. |
| | | | Similarity or nonsimilarity is defined on the basis of |
| | | | predetermined reference for each class of contents. |
| | Editing | Contents | 1. Expression input tool: Tool for providing a function of |
| | tool | generator | allowing convenient input, edit, and expression of an |
| | | | expression, using a language for expressing mathematical |
| | | | expressions |
| | | | 2. Problem generator: Tool for providing a function of |
| | | | allowing generating a mathematical expression, a statement |
| | | | part, and a geometric diagram on one problem script |
| | | | 3. Video editor: Tool having a function of editing and |
| | | | processing a lecture video into VOD |
| | | | 4. e-Book generator |
| | | | 5. Open LMS: Supports making LMS (learning management |
| | | | system), using an open source |
| | | | 6. Including other tools having the entire functions for |
| | | | mathematical learning |
| Others | Cart | Learning | Used for improving learning achievement by paying for an |
| | | cart | evaluation in terms of learning to purchase the same when |
| | | | used for learning |
| | | Shopping | Purchased after paying for an estimation for selling when it is |
| | | cart | not for learning |
| | Market | Contents | Market for distributing and dealing with mathematical |
| | | store | learning contents |
| | | On-line | On-line institute opened by integrating and applying |
| | | institute | mathematical learning contents by a provider |

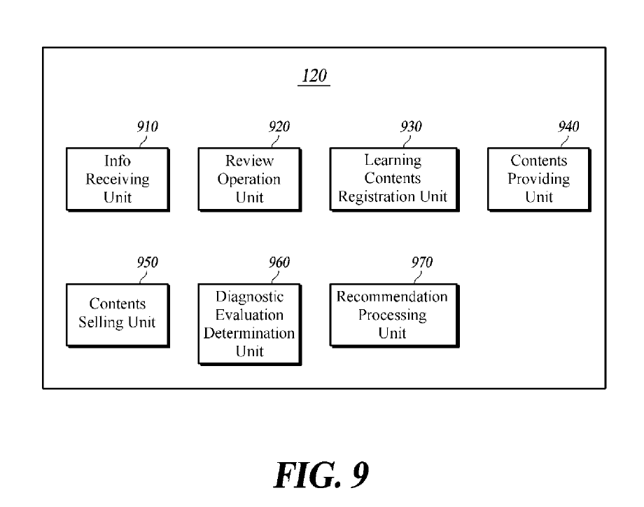

FIG. 9 is a schematic block diagram of internal modules of a learning ability diagnostic apparatus according to at least one embodiment which provides a learning market.

Learning ability diagnostic apparatus 120 according to the present embodiment includes an information receiving unit 910, a review operation unit 920, a learning contents registration unit 930, a contents providing unit 940, a contents selling unit 950, a diagnostic evaluation determination unit 960, and a recommendation processing unit 970. Although learning ability diagnostic apparatus 120 includes only information receiving unit 910, review operation unit 920, learning contents registration unit 930, contents providing unit 940, contents selling unit 950, diagnostic evaluation determination unit 960, and recommendation processing unit 970 in the present embodiment, this is an example of the spirit of the present embodiment, and the components of learning ability diagnostic apparatus 120 is changed and modified in various ways by those skilled in the art without departing from the scope of the present embodiment.

Information receiving unit 910 receives a production of learning contents from supply terminal 102. The learning contents may be mathematical contents including expression information and text information in the Math ML format, but are not limited thereto.

Review operation unit 920 carries out review to register the learning contents on a learning market. Review operation unit 920 reviews the learning contents on the basis of at least one of the information about possibility of carrying the learning contents and the information on checking errors. Review operation unit 920 checks whether contents the same as the learning contents requested to be registered is found in the contents registered already in the learning market, and when the same contents are found as the result of checking, it transmits a message saying ‘unsuitable’ for rejecting the learning contents requested to be registered to the supply terminal. Review operation unit 920 checks similarity to the contents registered already, when there are no contents the same as the contents registered already, and when the checked similarity is less than a predetermined value, it registers the learning contents requested to be registered on the learning market. Review operation unit 920 checks similarity between the text information or the expression information included in the learning contents registered already and the text information and the expression information included in the learning content, on the basis of matching ratio. Review operation unit 920 inactivates the contents that are the same and recorded more than a predetermined number by the consumer terminal, in the learning contents registered on the learning market. The learning market includes one or more of a general market, a sale market, and a learning market.

Learning contents registering unit 930 gives the learning contents semantic information on the basis of the basic information received from supply terminal 102 and then registers the learning contents on the learning market, when finishing authenticating through review. Learning contents registration unit 930 shares the learning contents registered on the learning market with an SNS (social network service) server and a server that supports searching which include one or more of Blog, Twitter, Facebook, homepage, and mini homepage.

Learning contents registration unit 930 selects and gives, as semantic information, information with high relevance to the basic information in the information with high similarity or identity in learning meaning determined on the basis of the basic information. The basic information includes one or more of the title information, the explanation information, the image information, and the keyword information of the learning content. Learning contents registration unit 930 includes a generation module described in [Table 10] as a component to give the semantic information to the learning content.

TABLE 10

| Item | Detail |
|---|---|
| Ontology | Knowledge is conceptualized with reference to database |
| modeler | Taxonomy rule is applied for hierarchical structure |
| | in conceptualization |
| | Conceptualizing terminologies are provided to ontology |
| | generator |
| Ontology | Terminologies received from ontology modeler are |
| generator | specified |
| | Making in ontology language (Knowledge expression |
| | language) |
| Ontology | Validity of a production of ontology is reviewd |
| validator | Ontology language is grammatically reviewed |

On the other hand, learning contents registration unit 930 includes a management module described in [Table 11] as a component to give the semantic information to the learning content.

TABLE 11

| Item | Detail |
|---|---|
| Annotation | Tool for processing annotation in ontology |
| tool | Provided for every user who use ontology |
| | Provides the same language as an expression |
| | language of ontology in a language for annotation |
| Ontology | Edits the contents of ontology |
| editor | Provide edition of components of ontology |
| | Selects the version of ontology to edit |
| Ontology | Provides both automatic and manual integration |
| integration | method |
| tool | Provide a method such as mechanical learning for |
| | automatic integration method |
| | Provides a method that user can integrate in person |
| | with an editor such as ontology editor for a manual |
| | method |

On the other hand, learning contents registration unit 930 includes a storage module described in [Table 12] as a component to give the semantic information to the learning content.

TABLE 12

| Item | Detail |
|---|---|
| Ontology | Stores ontology and annotation |
| repository | Classifies and stores ontology such as a file server |
| Ontology | Reviews integrity of ontology |
| evaluator | |
| Versioning | provides ontology version due to a change in ontology |
| tool | |

Contents providing unit 940 transmits the information on purchase of the learning contents to consumer terminal 104 accessing the learning market 104. Contents providing unit 940 transmits the information on purchase of the learning contents with the basic information matching with the information on a search word inputted through a search server from consumer terminal 104. Contents providing unit 940 finds out the relationship between the search word and the learning content, using inferring rules applied on the basis of the Ontology information corresponding to the search word information, and then transmits the information on purchase corresponding to the relationship to consumer terminal 104. On the other hand, contents providing unit 940 includes components described in [Table 13] to find out the information on purchase of learning contents with basic information matching with keyword information inputted through a search server.

TABLE 13

| Components | Detail |
|---|---|
| RDF query | processes RDF query language received from a |
| engine | web document |
| | Provides information on corresponding ontology |
| | and relating ontology to ontology crawler |
| Ontology | Search ontology provided from RDF query engine |
| crawler | Provide searched ontology to inference engine |
| Inference | Carries out function of inference by applying |
| engine | inference rules from ontology |
| | Provide relating terminologies to search engine |
| | by finding out the relevance of query languages |

On the other hand, contents providing unit 940 includes components described in [Table 14] to search texts and expressions included in the information on purchase.

TABLE 14

| Components | Detail |
|---|---|
| Document editor | Editor for providing semantic web language with |
| Problem editor | mathematical symbols |
| | Same as existing HTML and XML editors |
| Document parser | Review XML grammar of a production of document |
| Document | Reviews validity with reference to schema or |
| validator | ontology |

Contents selling unit 950 sells the learning contents for sale or learning, when there is a request for purchase in the information on purchase. Contents selling unit 950 provides tools for editing and making for the learning contents to consumer terminal 104 that purchased the learning content, and permits secondary sale of learning contents edited by the tools for editing and making, when the learning contents is sold for learning. The semantic information has a data structure including a background part including one or more of the information on the learner's nation, the information of the learner's object, the information of the learner's grade, the information of importance of the learner, and the information of the origin of the learner, a statement part including one or more of the information on the main subject of learning, the information on the learning circumstances, the information of keyword of learning, and the information on the format of the key-expression of learning, a solution part including one or more of the information on the learning solution pattern, the information on the cognitive field in learning, the information on notice in learning, and the information on the difficulty level of learning, and a statistic part including one or more of the information on the correct ratio in learning, the information on the frequency in use of learning, the information of frequency of setting in learning, the information of the number of recommendations, and the information on the response time.

When the learning contents are sold for learning, diagnostic evaluation determination unit 960 generates diagnostic evaluation information in accordance with the information of learning result of the learning contents received from the consumer terminal and stores the diagnostic evaluation information. When learning evaluation data is included in the learning content, diagnostic evaluation determination unit 960 receives answer data corresponding to the learning evaluation data from consumer terminal 104 and transmits the data resulting from collective diagnostic evaluation or one-to-one diagnostic evaluation on the basis of checking the answer data to consumer terminal 104. The learning result information includes one or more of the information of the number of times of downloading the learning content, the information on the number of times of driving the learning content and the information on learning achievement. Recommendation processing unit 970 stores the recommendation information received from consumer terminal 104. The recommendation information includes one or more of learning data recommendation information, learning problem recommendation information, mentor recommendation information and learning template recommendation information.

According to at least one embodiment of the present disclosure as described above, learners can use a terminal and be inspired to learn further by automatically diagnosing an understanding of required concepts for learning and a problem-solving ability by type in accordance with the learning target and the learning history of the learners through a semantic model such as a mathematic problem, and by providing the learners with data based on the diagnosis result.

In another embodiment, all of users having learning contents are enabled to make free commercial transactions of their learning contents on a learning market where learners are able to pay for the learning contents for improving learning ability and achievement, to readily secure a relevant learning content, and the contents provider is rewarded by a profit off the learning contents in real time.

In yet another embodiment, learners can not only improve learning ability and achievement, using various learning assistant tools and learning contents, but make a profit by registering and selling owned or created learning contents, by making and selling learning contents with a leased learning contents editing tool on hire or by purchasing learning contents from a contents provider to resell the learning contents processed or combined.

The embodiments as described above are applicable to an apparatus and method for diagnosing learning ability. According to the embodiments, learners using a terminal can be motivated to learn by automatically diagnosing understanding of concepts for learning and problem-solving ability by problem type in accordance with the learning target and the learning history of the learners through a semantic model such as a mathematic problem, and by providing the learners with data based on the diagnosis result and all the people are allowed to freely deal own learning contents on a learning market.

The various embodiments as described above may be implemented in the form of one or more program commands that can be read and executed by a variety of computer systems and be recorded in any non-transitory, a computer-readable recording medium. The computer-readable recording medium may include a program command, a data file, a data structure, etc. alone or in combination. The program commands written to the medium are designed or configured especially for the at least one embodiment, or known to those skilled in computer software. Examples of the computer-readable recording medium include magnetic media such as a hard disk, a floppy disk, and a magnetic tape, optical media such as a CD-ROM and a DVD, magneto-optical media such as an optical disk, and a hardware device configured especially to store and execute a program, such as a ROM, a RAM, and a flash memory. Examples of a program command include a premium language code executable by a computer using an interpreter as well as a machine language code made by a compiler. The hardware device may be configured to operate as one or more software modules to implement one or more embodiments of the present invention. In some embodiments, one or more of the processes or functionality described herein is/are performed by specifically configured hardware (e.g., by one or more application specific integrated circuits or ASIC(s)). Some embodiments incorporate more than one of the described processes in a single ASIC. In some embodiments, one or more of the processes or functionality described herein is/are performed by at least one processor which is programmed for performing such processes or functionality.

While the present disclosure has been shown and described with reference to certain embodiments thereof, it will be understood by those skilled in the art that various changes in form and details may be made therein without departing from the subject matter, the spirit and scope of the present disclosure as defined by the appended claims. Specific terms used in this disclosure and drawings are used for illustrative purposes and not to be considered as limitations of the present disclosure.

1. An apparatus for diagnosing a learning ability, the apparatus comprising:
a receiving unit configured to receive, from a terminal, chapter-related information or problem-related information to diagnose a learning ability of a learner; and
a semantic information generator configured to generate, responsive to each piece of problem information included in the chapter-related information or problem-related information, semantic information with structural information of the problem information, the problem information having subject-specific problem information distinguished from the semantic information.

2. The apparatus of claim 1, further comprising:
a weak field calculator configured to receive answer data to said each piece of the problem information from the terminal, generate wrong answer data obtained by carrying out marking on the answer data, and calculate a weak field on the basis of the semantic information corresponding to the wrong answer data;
an equation generator configured to generate a logic equation for solving the weak field; and
an equation solver configured to transmit a solution to the logic equation to the terminal.

3. The apparatus of claim 2, further comprising:
a problem pattern relational structure extractor configured to extract problem pattern information of said each piece of the problem information on the basis of the semantic information of the wrong answer data, extract skill information and conceptual information for solution of said each piece of the problem information, and extract the relationship between the skill information and the conceptual information.

4. The apparatus of claim 3, wherein the equation generator is configured to generate the logic equation on the basis of the relationship among the problem pattern information, the skill information and the conceptual information.

5. The apparatus of claim 3, wherein the problem pattern relational structure extractor in configured to read out structure information of problems relating to a chapter to diagnose, from the semantic information of problems.

6. The apparatus of claim 3, wherein the problem pattern relational structure extractor in configured to include a logic model converter configured to express a relational structure of the problem pattern information, the skill information, and the conceptual information, as a logic model including CNF (conjunctive normal form) or DNF (disjunctive normal form).

7. The apparatus of claim 2, wherein the weak field calculator is configured to combine queries for some or all of properties for each chapter, each problem type, each difficulty level and each learning feature to generate the wrong answer data obtained by carrying out marking on the answer data.

8. The apparatus of claim 2, wherein when the logic equation has a plurality of solutions, the equation solver is configured to determine whether values of variables of the logic equation are constant for the solutions.

9. The apparatus of claim 8, wherein when the values of the variables of the logic equation are not constant for the solutions, the equation solver is configured to select and transmit to the terminal additional problem information for determining the values of the variables, and determine the values of the variables on the basis of additional answer data for the additional problem information received from the terminal.

10. The apparatus of claim 2, wherein when the logic equation has a plurality of solutions, the equation solver is configured to determine values that are constant for the solutions as values of variables of the logic equation.

11. The apparatus of claim 2, wherein when the logic equation has a single solution, the equation solver is configured to determine a value of the single solution as values of variables of the logic equation.

12. The apparatus of claim 2, wherein when the logic equation has no solution, the equation solver is configured to determine values of variables of the logic equation in accordance with whether there is a consistency of values extracted directly from the logic equation.

13. The apparatus of claim 2, further comprising a traffic processing unit including
a control unit configured to control signals or data that are processed by the apparatus for diagnosing a learning ability, and
an interface unit configured to interwork with a communication network.

14. An apparatus for diagnosing a learning ability, the apparatus comprising:
an information receiving unit configured to receive a production of learning contents from a supply terminal;
a review operation unit configured to carry out a review to register the learning contents on a learning market;
a learning contents registration unit, in response to an authentication completed through the review, configured to give the learning contents semantic information based on basic information received from the supply terminal and register the learning contents on the learning market;
a contents providing unit configured to transmit purchase information on the learning contents to a consumer terminal accessing the learning market; and
a contents selling unit configured to sell the learning contents, when there is a purchase request in response to the purchase information.

15. The apparatus of claim 14, further comprising:
a diagnostic evaluation determination unit configured to generate diagnostic evaluation information in accordance with information on learning results of the learning contents received from the consumer terminal and store the diagnostic evaluation information; and
a recommendation processing unit configured to store recommendation information received from the consumer terminal, wherein the recommendation information includes one or more of learning data recommendation information, learning problem recommendation information, mentor recommendation information and learning template recommendation information.

16. A method of diagnosing a learning ability, the method performed by an apparatus for diagnosing the learning ability and comprising:
receiving, from a terminal, chapter-related information or problem-related information to diagnose for a learning ability of a learner;
generating, responsive to each piece of problem information included in the chapter-related information or problem-related information, semantic information with structural information of the problem information, the problem information having subject-specific problem information distinguished from the semantic information;
receiving answer data to said each piece of the problem information from the terminal;
generating wrong answer data obtained by performing marking on the answer data;
calculating a weak field on the basis of the semantic information corresponding to the wrong answer data;
generating a logic equation for solving the weak field; and
transmitting a solution to the logic equation to the terminal.

17. The method of claim 16, further comprising:
extracting problem pattern information of said each piece of the problem information on the basis of the semantic information of the wrong answer data;
extracting skill information or conceptual information for solution of said each piece of the problem information; and
extracting the relationship between the skill information and the conceptual information therefrom.

18. The method of claim 16, wherein the generating of the wrong answer data comprises
combining queries for some or all of properties for each chapter, each problem type, each difficulty level and each learning feature to generate the wrong answer data.

19. The method of claim 16, further comprising:
determining whether values of variables of the logic equation are constant for the solutions when the logic equation has a plurality of solutions; and
when the values of the variables of the logic equation are not constant for the solutions, selecting and transmitting to the terminal additional problem information for determining the values of the variables, and determining the values of the variables on the basis of additional answer data for the additional problem information received from the terminal.

20. The method of claim 16, further comprising:
when the logic equation has a single solution, determining the value of the single solution as the values of the variables of the logic equation with the single solution; and
when the logic equation has no solution, determining the values of the variables of the logic equation without a solution in accordance with whether a consistency of values extracted directly from the logic equation.
